(19) United States
(12) Patent Application Publication
(10) Pub. No.: US 2019/0260435 A1
(43) Pub. Date: Aug. 22, 2019

(54) Uplink Transmission Schemes In Mobile Communications

(71) Applicant: MediaTek Inc., Hsinchu City (TW)

(72) Inventor: Weidong Yang, San Diego, CA (US)

(21) Appl. No.: 16/275,322

(22) Filed: Feb. 14, 2019

Related U.S. Application Data
(60) Provisional application No. 62/631,642, filed on Feb. 17, 2018.

(51) Int. Cl. H04B 7/0456; H04W 72/12; H04B 7/0452

(52) U.S. Cl. CPC H04B 7/0456; H04B 7/0452; H04W 72/1268

(57) ABSTRACT

Various examples with respect to uplink (UL) transmission schemes for frequency selective precoding in UL transmissions in mobile communications are described. A processor of a user equipment (UE) receives a control signal from a network node of a wireless network which is in wireless communication with a plurality of UEs. The control signal may allocate one or more subbands to the UE. The processor defines one or more physical resource blocks (PRBs) corresponding to the one or more subbands based on a common reference point used by the plurality of UEs. The processor then performs frequency selective precoding on the one or more PRBs.

### CROSS REFERENCE TO RELATED PATENT APPLICATION(S)

The present disclosure is part of a non-provisional application claiming the priority benefit of U.S. Patent Application Nos. 62/631,642, filed 17 Feb. 2018, the content of which is incorporated by reference in its entirety.

### TECHNICAL FIELD

The present disclosure is generally related to mobile communications and, more particularly, to uplink transmission schemes in mobile communications.

### BACKGROUND

Unless otherwise indicated herein, approaches described in this section are not prior art to the claims listed below and are not admitted as prior art by inclusion in this section.

In 5^{th}-Generation (5G)/New Radio (NR) mobile communications, with a large number of receive (RX) antennas on a network node/base station (e.g., gNB) at the network side, uplink (UL) multi-user multiple-input multiple-output (MU-MIMO) transmissions can simplify RX processing by the network node, especially with frequency selective precoding at the user equipment (UE) side. Thus, it is important to ensure that a network node can schedule NR UEs in UL MU-MIMO (e.g., a UE performing wideband precoding in accordance with Rel-15 of the 3^{rd}-Generation Partnership Project (3GPP) specification and another UE performing subband precoding in accordance with Rel-16 of the 3GPP specification, with MU-MIMO pairing and MIMO demodulation conducted over these two UEs). In such cases, aligned resource allocations over the overlapping allocations between the two UEs becomes necessary. However, current NR downlink control design does not support frequency selective precoding for UL transmissions.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose schemes, solutions, concepts, designs, methods and apparatuses pertaining to UL transmission schemes for frequency selective precoding in UL transmissions in mobile communications.

In one aspect, a method may involve a processor of a UE receiving a control signal from a network node of a wireless network which is in wireless communication with a plurality of UEs, with the control signal allocating one or more subbands to the UE. The method may also involve the processor defining one or more physical resource blocks (PRBs) corresponding to the one or more subbands based on a common reference point used by the plurality of UEs. The method may further involve the processor performing frequency selective precoding on the one or more PRBs.

In one aspect, an apparatus implementable in a UE may include a transceiver and a processor coupled to the transceiver. The transceiver may be capable of wirelessly communicating with a network node of a wireless network which is in wireless communication with a plurality of UEs. The processor may be capable of receiving, via the transceiver, a control signal from the network node, with the control signal allocating one or more subbands to the UE. The processor may be also capable of defining one or more PRBs corresponding to the one or more subbands based on a common reference point used by the plurality of UEs. The processor may be further capable of performing frequency selective precoding on the one or more PRBs.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies wherever applicable such as, for example and without limitation, Long-Term Evolution (LTE), LTE-Advanced, LTE-Advanced Pro, Internet-of-Things (IoT) and Narrow Band Internet of Things (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario in accordance with an implementation of the present disclosure.

FIG. 2 is a diagram of an example wireless communication system in accordance with an implementation of the present disclosure.

FIG. 3 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to UL transmission schemes for frequency selective precoding in UL transmissions in mobile communications. Under various proposed schemes in accordance with the present disclosure, to support frequency selective precoding in UL transmissions, a network node may semi-statically or dynamically signal a UE with a physical resource block (PRB) bundle size. Moreover, PRB bundles for physical uplink shared channel (PUSCH) may be referred to a common reference point (e.g., common PRB 0).

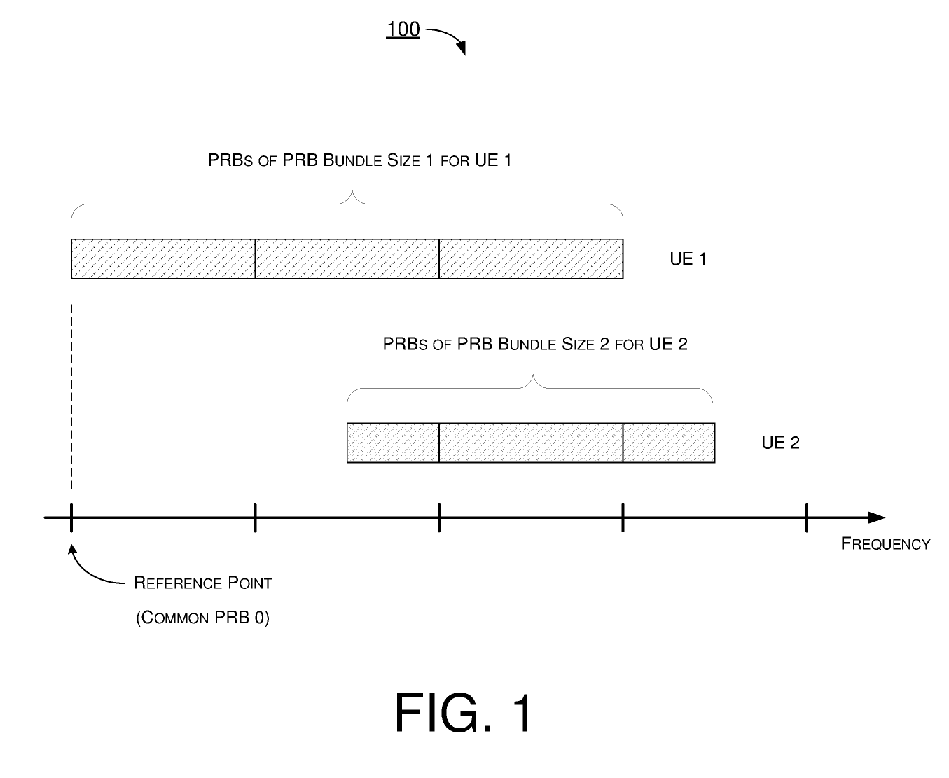

FIG. 1 illustrates an example scenario 100 in accordance with an implementation of the present disclosure. Under a proposed scheme in accordance with the present disclosure, each of a plurality of UEs in wireless communication with a network node (e.g., gNB) of a wireless network (e.g., 5G/NR mobile network) may be semi-statically or dynamically signaled by the network node a respective PRB bundle size. For instance, the network node may semi-statically or dynamically transmit downlink control information (DCI) to each of the UEs to indicate a respective PRB bundle size of one or more PRBs, corresponding to one or more subbands, allocated to the UE. The respective PRB bundle size for a given UE may be used by the UE to define a starting point and an ending point of one or more PRBs, corresponding to one or more subbands of a bandwidth part (BWP), allocated to the UE for UL transmission to the network node in a PUSCH. The allocation of the respective PRB bundle size for each UE may be indicated with reference to a common reference point (e.g., common PRB 0).

In scenario 100, the PRB bundle size of a first number of PRBs allocated to a first UE (UE 1) and the PRB bundle size of a second number of PRBs allocated to a second UE (UE 2) may be different. Advantageously, even though the PRB bundle sizes for the UEs may be different, each of the UEs may be able to respective define one or more PRBs based on the allocated PRB bundle size based on a common reference point (e.g., common PRB 0) and perform frequency selecting precoding on the respective one or more PRBs.

### Illustrative Implementations

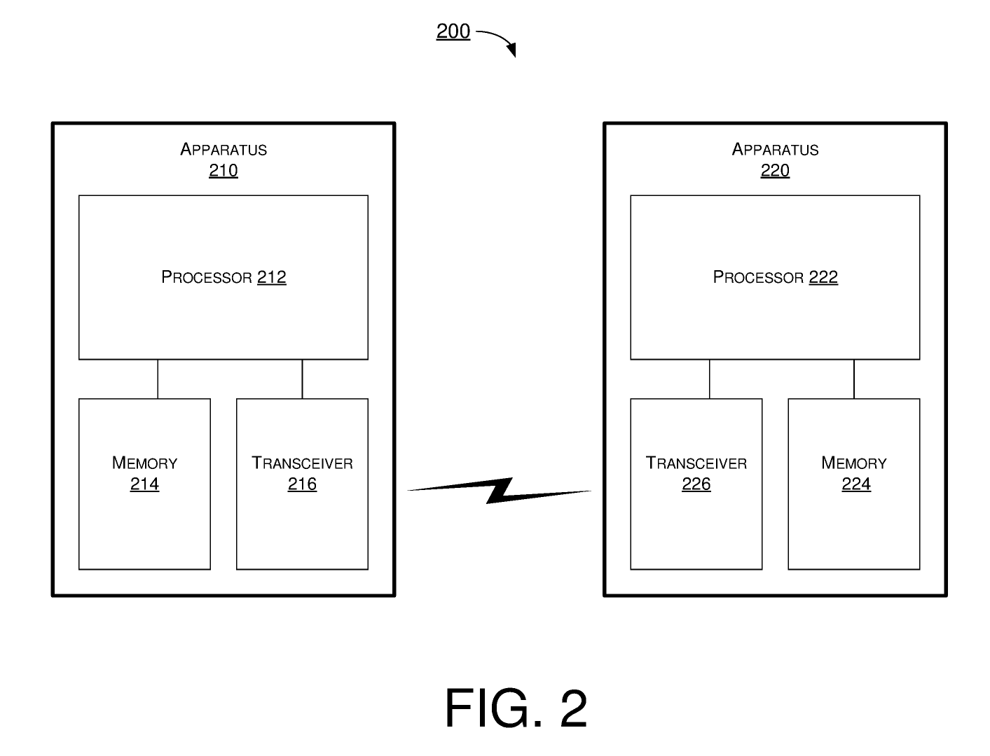

FIG. 2 illustrates an example wireless communication system 200 in accordance with an implementation of the present disclosure. Wireless communication system 200 may involve an apparatus 210 and an apparatus 220 wirelessly connected to each other. Each of apparatus 210 and apparatus 220 may perform various functions to implement procedures, schemes, techniques, processes and methods described herein pertaining to UL transmission schemes for frequency selective precoding in UL transmissions in mobile communications, including the various procedures, scenarios, schemes, solutions, concepts and techniques described above as well as process 300 described below.

Each of apparatus 210 and apparatus 220 may be a part of an electronic apparatus, which may be a UE such as a portable or mobile apparatus, a wearable apparatus, a wireless communication apparatus or a computing apparatus. For instance, each of apparatus 210 and apparatus 220 may be implemented in a smartphone, a smartwatch, a personal digital assistant, a digital camera, or a computing equipment such as a tablet computer, a laptop computer or a notebook computer. Moreover, each of apparatus 210 and apparatus 220 may also be a part of a machine type apparatus, which may be an IoT or NB-IoT apparatus such as an immobile or a stationary apparatus, a home apparatus, a wire communication apparatus or a computing apparatus. For instance, each of apparatus 210 and apparatus 220 may be implemented in a smart thermostat, a smart fridge, a smart door lock, a wireless speaker or a home control center. Alternatively, each of apparatus 210 and apparatus 220 may be implemented in the form of one or more integrated-circuit (IC) chips such as, for example and without limitation, one or more single-core processors, one or more multi-core processors, one or more reduced-instruction-set-computing (RISC) processors or one or more complex-instruction-set-computing (CISC) processors.

Each of apparatus 210 and apparatus 220 may include at least some of those components shown in FIG. 2 such as a processor 212 and a processor 222, respectively. Each of apparatus 210 and apparatus 220 may further include one or more other components not pertinent to the proposed scheme of the present disclosure (e.g., internal power supply, display device and/or user interface device), and, thus, such component(s) of each of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, one or more RISC processors, or one or more CISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged and configured to perform specific tasks pertaining to UL transmission schemes for frequency selective precoding in UL transmissions in mobile communications in accordance with various implementations of the present disclosure. In some implementations, each of processor 212 and processor 222 may include an electronic circuit with hardware components implementing one or more of the various proposed schemes in accordance with the present disclosure. Alternatively, other than hardware components, each of processor 212 and processor 222 may also utilize software codes and/or instructions in addition to hardware components to implement UL transmission schemes for frequency selective precoding in UL transmissions in mobile communications in accordance with various implementations of the present disclosure.

In some implementations, apparatus 210 may also include a transceiver 216 coupled to processor 212 and capable of wirelessly transmitting and receiving data, signals and information. In some implementations, transceiver 216 may be equipped with a plurality of antenna ports (not shown) such as, for example, four antenna ports. That is, transceiver 216 may be equipped with multiple transmit antennas and multiple receive antennas for MU-MIMO wireless communications. In some implementations, apparatus 210 may further include a memory 214 coupled to processor 212 and capable of being accessed by processor 212 and storing data therein. In some implementations, apparatus 220 may also include a transceiver 226 coupled to processor 222 and capable of wirelessly transmitting and receiving data, signals and information. In some implementations, transceiver 226 may be equipped with a plurality of antenna ports (not shown) such as, for example, four antenna ports. That is, transceiver 226 may be equipped with multiple transmit antennas and multiple receive antennas for MU-MIMO wireless communications. In some implementations, apparatus 220 may further include a memory 224 coupled to processor 222 and capable of being accessed by processor 222 and storing data therein. Accordingly, apparatus 210 and apparatus 220 may wirelessly communicate with each other via transceiver 216 and transceiver 226, respectively.

To aid better understanding, the following description of the operations, functionalities and capabilities of each of apparatus 210 and apparatus 220 is provided in the context of a mobile communication environment in which apparatus 210 is implemented in or as a UE and apparatus 220 is implemented in or as a network node (e.g., gNB or TRP) of a wireless network (e.g., 5G/NR mobile network) which is in wireless communication with a plurality of UEs (e.g., at least UE 1 and UE 2 in scenario 100) including apparatus 210 as one of the UEs.

Under various proposed schemes in accordance with the present disclosure, processor 212 of apparatus 210 may receive, via transceiver 216, a control signal from the network node, the control signal allocating one or more subbands to apparatus 210. Additionally, processor 212 may define one or more PRBs corresponding to the one or more subbands based on a common reference point used by the plurality of UEs. Moreover, processor 212 may perform frequency selective precoding on the one or more PRBs. Furthermore, processor 212 may perform, via transceiver 216, an UL transmission to the network node in a PUSCH using the precoded one or more PRBs.

In some implementations, in receiving the control signal that allocates the one or more subbands to apparatus 210, processor 212 may dynamically or semi-statically receive the control signal that indicates a PRB bundle size for apparatus 210. That is, instead of periodically transmitting a control signal that allocates subbands/PRBs to the UEs in wireless communication with the wireless network, apparatus 220 may dynamically or semi-statically transmit the control signal depending on a number of factors such as, for example and without limitation, a total number of UEs in wireless communication with the wireless network, a number of UEs among the plurality of UEs with data for UL transmissions, channel condition, and the like.

In some implementations, the control signal may include DCI.

In some implementations, the common reference point may include a common PRB 0.

In some implementations, the wireless network may include a 5G NR mobile network.

In some implementations, the UL transmission may include a MU-MIMO transmission.

### Illustrative Processes

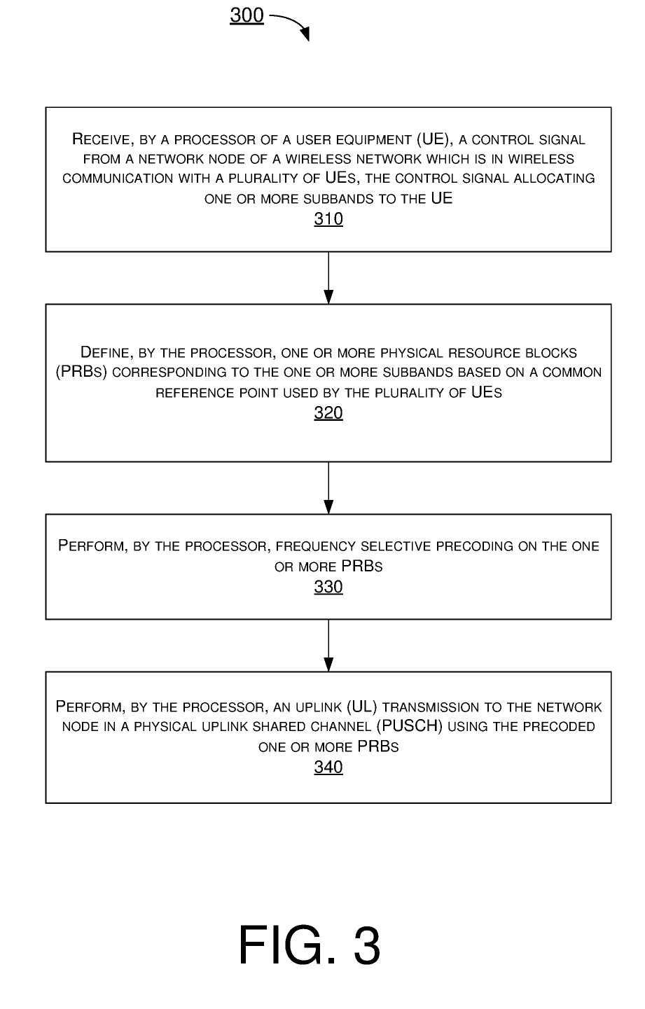

FIG. 3 illustrates an example process 300 in accordance with an implementation of the present disclosure. Process 300 may be an example implementation of the various procedures, scenarios, schemes, solutions, concepts and techniques, or a combination thereof, whether partially or completely, with respect to UL transmission schemes for frequency selective precoding in UL transmissions in mobile communications in accordance with the present disclosure. Process 300 may represent an aspect of implementation of features of apparatus 210 and/or apparatus 220. Process 300 may include one or more operations, actions, or functions as illustrated by one or more of blocks 310, 320, 330 and 340. Although illustrated as discrete blocks, various blocks of process 300 may be divided into additional blocks, combined into fewer blocks, or eliminated, depending on the desired implementation. Moreover, the blocks of process 300 may executed in the order shown in FIG. 3 or, alternatively, in a different order. Furthermore, one or more of the blocks of process 300 may be repeated one or more times. Process 300 may be implemented by apparatus 210 or any suitable UE or machine type devices. Solely for illustrative purposes and without limitation, process 300 is described below in the context of apparatus 210 as a UE and apparatus 220 as a network node (e.g., gNB or TRP) of a wireless network (e.g., 5G/NR mobile network). Process 300 may begin at block 310.

At 310, process 300 may involve processor 212 of apparatus 210 as a UE receiving, via transceiver 216, a control signal from apparatus 220 as a network node of a wireless network which is in wireless communication with a plurality of UEs. The control signal may allocate one or more subbands to apparatus 210. Process 300 may proceed from 310 to 320.

At 320, process 300 may involve processor 212 defining one or more PRBs corresponding to the one or more subbands based on a common reference point used by the plurality of UEs. Process 300 may proceed from 320 to 330.

At 330, process 300 may involve processor 212 performing frequency selective precoding on the one or more PRBs. Process 300 may proceed from 330 to 340.

At 340, process 300 may involve processor 212 performing, via transceiver 216, an UL transmission to apparatus 220 in a PUSCH using the precoded one or more PRBs

In some implementations, in receiving the control signal that allocates the one or more subbands to apparatus 210, process 300 may involve processor 212 dynamically or semi-statically receiving the control signal that indicates a PRB bundle size for apparatus 210.

In some implementations, the control signal may include DCI.

In some implementations, the common reference point may include a common PRB 0.

In some implementations, the wireless network may include a 5G NR mobile network.

In some implementations, the UL transmission may include a MU-MIMO transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), a control signal from a network node of a wireless network which is in wireless communication with a plurality of UEs, the control signal allocating one or more subbands to the UE;
defining, by the processor, one or more physical resource blocks (PRBs) corresponding to the one or more subbands based on a common reference point used by the plurality of UEs; and
performing, by the processor, frequency selective precoding on the one or more PRBs.

2. The method of claim 1, wherein the receiving of the control signal that allocates the one or more subbands to the UE comprises dynamically or semi-statically receiving the control signal that indicates a PRB bundle size for the UE.

3. The method of claim 1, wherein the control signal comprises downlink control information (DCI).

4. The method of claim 1, wherein the common reference point comprises a common PRB 0.

5. The method of claim 1, wherein the wireless network comprises a 5^{th}-Generation (5G) New Radio (NR) mobile network.

6. The method of claim 1, further comprising:
performing, by the processor, an uplink (UL) transmission to the network node in a physical uplink shared channel (PUSCH) using the precoded one or more PRBs.

7. The method of claim 5, wherein the UL transmission comprises a multi-user multiple-input multiple-output (MU-MIMO) transmission.

8. An apparatus implemented in a user equipment (UE), comprising:
a transceiver capable of wirelessly communicating with a network node of a wireless network which is in wireless communication with a plurality of UEs; and
a processor coupled to the transceiver, the processor capable of:
receiving, via the transceiver, a control signal from the network node, the control signal allocating one or more subbands to the UE;
defining a starting point for precoding one or more physical resource blocks (PRBs) corresponding to the one or more subbands based on a common reference point used by the plurality of UEs; and
performing frequency selective precoding on the one or more PRBs.

9. The apparatus of claim 8, wherein, in receiving the control signal that allocates the one or more subbands to the UE, the processor is capable of dynamically or semi-statically receiving the control signal that indicates a PRB bundle size for the UE.

10. The apparatus of claim 8, wherein the control signal comprises downlink control information (DCI).

11. The apparatus of claim 8, wherein the common reference point comprises a common PRB 0.

12. The apparatus of claim 8, wherein the wireless network comprises a 5^{th}-Generation (5G) New Radio (NR) mobile network.

13. The apparatus of claim 8, wherein the processor is further capable of:
performing, via the transceiver, an uplink (UL) transmission to the network node in a physical uplink shared channel (PUSCH) using the precoded one or more PRBs.

14. The apparatus of claim 13, wherein the UL transmission comprises a multi-user multiple-input multiple-output (MU-MIMO) transmission.
